(19) United States
(12) Patent Application Publication
(10) Pub. No.: US 2025/0033511 A1
(43) Pub. Date: Jan. 30, 2025

(54) METHOD FOR PROVIDING RECOMMENDED CHARGING PATH, CHARGING STATION INFORMATION PROVISION SERVER FOR PERFORMING SAME, AND CHARGING STATION INFORMATION PROVISION APPLICATION FOR PROVIDING RECOMMENDED CHARGING PATH

(71) Applicant: TBU INC., Seoul (KR)

(72) Inventors: Sang Jin PAIK, Seoul (KR); Jung Gwon SHIN, Gyeonggi-do (KR)

(73) Assignee: TBU INC., Seoul (KR)

(21) Appl. No.: 18/714,089

(22) PCT Filed: Nov. 11, 2022
(86) PCT No.: PCT/KR2022/017700

§ 371 Date: May 28, 2024

(30) Foreign Application Priority Data
Nov. 29, 2021 (KR) 10-2021-0167597

(51) Int. Cl. B60L 53/66; B60L 53/68

(52) U.S. Cl. CPC B60L 53/66; B60L 53/68; B60L 2240/72

(57) ABSTRACT

A charging station information provision server receives a route recommendation request including route configuration information from an external device, in response to the received route recommendation request, searches for a direct route based on the route configuration information, selects a charging station candidate group based on the direct route using a charging station selection model with an input of condition information for customized recommendations, vehicle information, road condition information, and information about charging stations, uses a route recommendation model to configure at least one recommended charging route, based on the selected charging station candidate group, and transmits the at least one recommended charging route to the external device.

### TECHNICAL FIELD

The present disclosure relates to a method of providing a recommended charging route, a charging station information providing server that performs the method, and a charging station information providing application that provides a recommended charging route.

### BACKGROUND ART

The electric vehicle market is growing rapidly every day due to the rapidly increasing demand for electric vehicles. Nevertheless, electric vehicle charging infrastructure is insufficient, and there are difficulties in supplying a sufficient number of charging stations due to regional characteristics and characteristics of the built environment.

When driving an electric vehicle to your destination, the navigation device provides a travel route from the departure point to the destination without considering the location of charging stations where electric vehicles may be charged, so when there is no charging station along the route or an appropriate amount of charge is not secured to the next charging station, problems arise that make driving electric vehicles difficult.

In order to use a public charging station or a charging station operated by a charging station operator, even if the user drives an electric vehicle and moves to a nearby charging station, problems may occur such as not being able to charge the vehicle due to a charger failure or having to use another charging station due to long waiting times.

### DISCLOSURE

### Technical Problem

The present disclosure provides a method of providing a recommended charging route via a charging station for vehicle charging, a charging station information providing server that performs the method, and a charging station information providing application that provides a recommended charging route.

### Technical Solution

A charging station information providing server according to the first aspect includes a communication interface unit; a memory to store instructions; and a processor configured to execute instructions to receive a route recommendation request including route configuration information from an external device through the communication interface unit, in response to the received route recommendation request, search for a direct route, based on the route configuration information, select a charging station candidate group based on the direct route using a charging station selection model with an input of condition information for customized recommendation, vehicle information, road condition information, and information about charging stations, configure at least one recommended charging route, based on the selected charging station candidates using a route recommendation model, and transmit the at least one recommended charging route to the external device through the communication interface unit.

A method of providing a recommended charging route performed by a charging station information providing server according to the second aspect includes receiving a route recommendation request including route configuration information from an external device; in response to the received route recommendation request, searching for a direct route based on the route configuration information; selecting a charging station candidate group based on the direct route using a charging station selection model with an input of condition information for customized recommendation, vehicle information, road condition information, and information about charging stations; configuring at least one recommended charging route, based on the selected charging station candidates using a route recommendation model; and transmitting the at least one recommended charging route to the external device.

A charging station information providing application stored in medium according to the third aspect is configured to cause a processor of a terminal device to perform a method of providing a recommended charging route, wherein the method of providing the recommended charging route includes detecting an input of a route recommendation request including route configuration information in a user interface upon execution of a charging station information providing application, transmitting the route recommendation request to a charging station information providing server, in response to the transmitting of the route recommendation request, receiving, from the charging station information providing server, at least one recommended charging route, wherein the at least one recommended charging route is configured by the charging station information providing server searching for a direct route based on the route configuration information, selecting a charging station candidate group based on the direct route using a charging station selection model with an input of condition information for customized recommendation, vehicle information, road condition information, and information about charging stations, and configuring the at least one recommended charging route, based on the selected charging station candidate group using a route recommendation model, and changing and outputting the user interface, based on the received at least one recommended charging route.

### DESCRIPTION OF DRAWINGS

FIG. 1 is a diagram for explaining a service environment that provides a recommended charging route.

FIG. 2 is a diagram for explaining the configuration and operation of a vehicle.

FIG. 3 is a diagram for explaining the configuration and operation of a user terminal.

FIG. 4 is a diagram for explaining the configuration and operation of the charging station information providing server.

FIG. 5 is a diagram for explaining a process of providing a recommended charging route in response to a route recommendation request.

FIG. 6 is a flowchart showing a method of providing a recommended charging route performed by a charging station information providing server.

FIG. 7 is a diagram illustrating an example of a route recommendation request input through a user interface upon execution of a charging station information providing application.

FIG. 8 is a detailed flowchart illustrating a process of configuring a recommended charging route, based on a charging station candidate group in a method of providing a recommended charging route.

FIG. 9 is a graph for explaining charging efficiency, based on the relationship between charger output, battery capacity, and charging execution time.

FIG. 10 is a diagram showing an example of configuring a recommended charging route, based on a charging station candidate group.

FIG. 11 is a diagram showing a recommended charging route output on the user interface by executing a charging station information providing application.

FIG. 12 is a diagram showing a detour route for via a charging station on a recommended charging route in the user interface by executing a charging station information providing application.

FIG. 13 is a diagram showing all charging stations included in the charging station candidate group selected to form a recommended charging route.

### MODE FOR INVENTION

Hereinafter, various embodiments are described in detail with reference to the drawings. In order to more clearly explain the characteristics of the embodiments, detailed descriptions of matters widely known to those skilled in the art to which the following embodiments belong are omitted.

Meanwhile, in this specification, when a configuration is said to be “connected” to another configuration, this includes not only the case of being “directly connected,” but also the case of being “connected with another configuration in between.” In addition, when a configuration “includes” another configuration, this means that other configurations may be further included rather than excluding other configurations, unless specifically stated to the contrary.

Additionally, terms including ordinal numbers such as ‘first’ or ‘second’ used in this specification may be used to describe various components, but the components should not be limited by the terms. The above terms are used solely for the purpose of distinguishing one component from another.

In addition, in this specification, based on various context information about users, vehicles, charging stations, roads, etc. ‘route recommendation’ is intended to provide users with customized route recommendation results that reflect the status or characteristics of the user, vehicle, charging station, road, etc., so the technical features of this specification may also be used for ‘route search’. When searching a route, based on various context information about users, vehicles, charging stations, roads, etc., in addition to specific navigation condition information, those skilled in the art are understand that the disclosed embodiments may be implemented in a modified form such as providing customized route search results. Therefore, hereinafter, the term ‘route recommendation’ used in this specification may be replaced with ‘route search’ or ‘route search and recommendation’. For example, ‘route recommendation request’ may be replaced with ‘route search request’ or ‘route search and recommendation request’. ‘Route recommendation query’ may be replaced with ‘route search query’ or ‘route search and recommendation query’. ‘Route recommendation model’ may be replaced with ‘route search model’ or ‘route search and recommendation model’.

In addition, in this specification, ‘direct route’ refers to a travel route that does not pass through a charging station from the origin to the destination, and ‘recommended charging route’ refers to a travel route that passes through a charging station from the origin to the destination.

These embodiments relate to a method of providing a recommended charging route, a charging station information providing server that performs the same, and a charging station information providing application that provides a recommended charging route, and detailed descriptions of matters widely known to those skilled in the art to which the following embodiments belong are omitted.

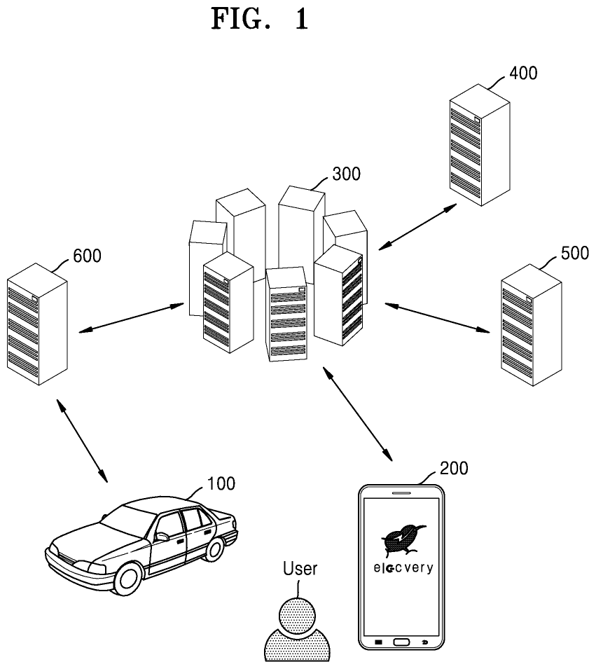

FIG. 1 is a diagram for explaining a service environment providing a recommended charging route.

A vehicle 100 refers to a transportation device or a movement device equipped with a rechargeable battery device. For example, the vehicle 100 may be an electric vehicle, a hybrid vehicle, an electric scooter, an electric kickboard, an electric two-wheeled vehicle, etc. that may be charged with electricity. The vehicle 100 may be driven by appropriately distributing the power of the battery device to places where power supply is needed inside the vehicle 100. When power is supplied to various parts of the vehicle 100 from the battery device, the battery device is discharged and needs to be recharged.

A user terminal 200 is a terminal device of a user who owns or uses the vehicle 100, and may request a route recommendation from a charging station information providing server 300. To do this, the charging station information providing application may be installed in the user terminal 200. The charging station information providing application is an application that provides services or functions related to charging stations for charging vehicles and may be installed on an external device, such as the user terminal 200 or the vehicle 100, but for convenience of description below, the description is made assuming an example of the charging station information providing application installed on the user terminal 200. When the charging station information providing application is executed, a home screen indicating services or functions supported by the application may be displayed, or a map-based user interface may be displayed. For example, when a user runs a charging station information providing application on the user terminal 200 and requests a route recommendation from the charging station information providing server 300, the user may receive recommended charging routes that travel via optimal charging stations to reach user's destination, and the user may also call a navigation application depending on this recommended charging route.

The charging station information providing server 300 may provide services related to the charging station. The charging station information providing server 300 may respond to a request received from the vehicle 100 or the user terminal 200 and provide information or services corresponding to the request. The charging station information providing server 300 may collect information about the charging station, road condition information, user information, vehicle information, etc. The charging station information providing server 300 may transmit the collected information or information obtained based on the collected information to the vehicle 100 or the user terminal 200. The charging station information providing server 300 may be implemented using technologies, such as cloud computing.

A road information providing server 400 may be a server that provides road condition information. The road information providing server 400 may be connected to the charging station information providing server 300 and may provide road condition information, such as detailed road information, traffic information, and toll gate costs to determine the status of the travel route.

A charging station operator server 500 may be a server that transmits information about the charging station to the charging station information providing server 300. However, the disclosure is not limited to such a name as the charging station operator server 500 and may be a server of a different type, such as an information brokerage server that may collect and transmit information about charging stations. When charging station status information, such as charger usage status, changes depending on the use of the charging station, the charging station operator server 500 may transmit the changed charging station status information to the charging station information providing server 300.

The vehicle information providing server 600, such as a vehicle manufacturer server, may store vehicle information of the vehicle 100 periodically or whenever vehicle operation ends. The vehicle information may include at least one of information, such as charging status information, location information, driving information, vehicle model, and charging port type information of the vehicle 100. A vehicle information providing server 600 may store driving pattern information, battery charge/discharge cycle information, and driving performance information, such as performance per watt, etc., which are determined from accumulated vehicle information. The charging station information providing server 300 may store such vehicle information in synchronization with the vehicle information providing server 600.

Hereinafter, embodiments in which a charging station information providing server 300 provides a recommended charging route via a charging station so that the vehicle 100 may be driven from a departure point to a destination in response to a route recommendation request from the user terminal 200 are described.

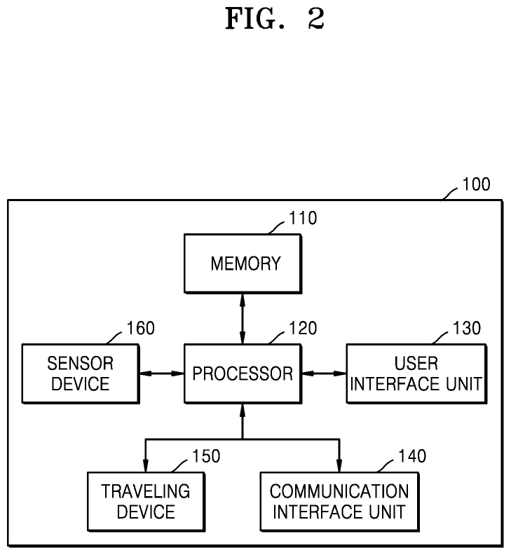

FIG. 2 is a diagram for explaining the configuration and operation of a vehicle 100.

Referring to FIG. 2, the vehicle 100 includes a memory 110, a processor 120, a user interface unit 130, a communication interface unit 140, a traveling device 150, and a sensor device 160. Anyone skilled in the art related to this embodiment knows that other general-purpose components may be included in addition to the components shown in FIG. 2.

The memory 110 may store software and/or computer programs. The memory 110 may store instructions executable by the processor 120. The processor 120 may access and use data stored in the memory 110 or store new data in the memory 110. The processor 120 may execute instructions stored in the memory 110. Processor 120 may include at least one processing module.

The user interface unit 130 may include an input unit that receives input from a user, such as a driver, and an output unit that provides information. The input unit may receive various types of input from the user, and the output unit may include a display panel and a controller that controls the display panel. The user interface unit 130 may be provided in the form of a touch screen that combines a display panel and a touch panel.

The communication interface unit 140 may communicate with other devices or servers. To do this, the communication interface unit 140 may include a communication module supporting at least one of various communication methods. For example, the communication interface unit 140 may be connected to the user terminal 200 or the vehicle information providing server 600 located outside the vehicle 100 and may transmit and receive data or information periodically or when there is a change in operation information of the vehicle 100.

The driving device 150 may include a brake, accelerator, steering device, battery device, drive motor, transmission, etc.

The sensor device 160 may include a sensor configured to sense information about the environment in which vehicle 100 is located and one or more actuators configured to modify the position or orientation of the sensors. Depending on embodiments, the sensor device may include at least one of a global positioning system (GPS), a camera, an inertial sensor, an acceleration sensor, a geomagnetic sensor, a temperature sensor, a humidity sensor, a barometric pressure sensor, a distance sensor, a speed sensor, an inertial measurement unit (IMU), and a RADAR device, and LiDAR device, but is not limited thereto.

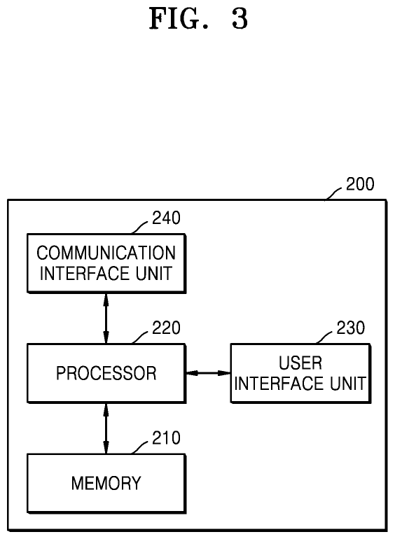

FIG. 3 is a diagram for explaining the configuration and operation of a user terminal 200.

Referring to FIG. 3, the user terminal 200 includes a memory 210, a processor 220, a user interface unit 230, and a communication interface unit 240. Anyone skilled in the art related to this embodiment knows that other general-purpose components may be included in addition to the components shown in FIG. 3. For example, the user terminal 200 may further include a location sensor such as a global positioning system (GPS) to obtain current location information.

The memory 210 may store software and/or computer programs. For example, the memory 210 may store programs, such as applications, application programming interface (API), and various types of data. The memory 210 may store instructions executable by processor 220.

The processor 220 may access and use data stored in the memory 210 or store new data in the memory 210. The processor 220 may execute instructions stored in the memory 210. The processor 220 may execute an application installed on the user terminal 200.

Processor 220 may include at least one processing module. The processor 220 may control other components included in the user terminal 200 to perform operations corresponding to execution results of instructions or computer programs.

The user interface unit 230 may include an input unit that receives input from the user and an output unit that provides information. The input unit can receive various types of input from the user and may include at least one of a keypad, a touch panel, and a pen recognition panel. The output unit may include a display panel and a controller that controls the display panel, and may be implemented in various ways, such as a liquid crystal display (LCD), organic light emitting diodes (OLED) display, active-matrix organic light-emitting diode (AM-OLED), and plasma display panel (PDP). The display panel may be implemented to be flexible or wearable. The user interface unit 230 may be provided in the form of a touch screen that combines a display panel and a touch panel.

The communication interface unit 240 may perform wired or wireless communication with other devices or networks. To do this, the communication interface unit 240 may include a communication module supporting at least one of various wired and wireless communication methods. For example, it may include communication modules that perform various types of mobile communication or ultra-wideband communication, such as short-range communication such as wireless fidelity (Wi-Fi) and Bluetooth, 3G, 4G, 5G, etc. The communication interface unit 240 may be connected to the vehicle 100 or charging station information providing server 300 located outside the user terminal 200 and may transmit and receive messages including various types of information or data.

The processor 220 may execute the instructions stored in the memory 210 to perform the following operations. According to one example, the processor 220 may detect the input of a route recommendation request including route configuration information in the user interface upon execution of the charging station information providing application and transmit the route recommendation request to the charging station information providing server 300. The route configuration information may include information about the departure point and destination, and may further include transit point. To request a route recommendation, in addition to route configuration information, scheduled departure time information, condition information for customized recommendation, or vehicle information may be additionally input. In a case of service subscribers or members, the condition information for customized recommendation, or vehicle information may be registered in advance on the charging station information providing server 300. The processor 220 may receive at least one recommended charging route from the charging station information providing server 300 in response to transmitting the route recommendation request. The charging station information providing server 300 may search for a direct route, based on the route configuration information received from the user terminal 200, select charging station candidates, based on the direct route using a charging station selection model with an input of condition information for customized recommendations, vehicle information, road condition information, and information about charging stations, and transmit at least one recommended charging route configured based on the selected charging station candidate group to the user terminal 200 using the route recommendation model. The processor 200 may change and output a user interface, based on at least one recommended charging route received from the charging station information providing server 300.

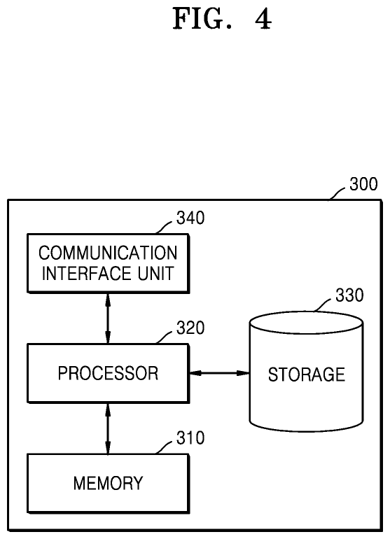

FIG. 4 is a diagram for explaining the configuration and operation of the charging station information providing server 300.

Referring to FIG. 4, the charging station information providing server 300 includes a memory 310, a processor 320, a storage 330, and a communication interface unit 340. Anyone skilled in the art related to this embodiment knows that other general-purpose components may be included in addition to the components shown in FIG. 4.

Each component of the block diagram of FIG. 4 may be separated, added, or omitted depending on the implementation method of the charging station information providing server 300. That is, depending on the implementation method, one component may be subdivided into two or more components, two or more components may be combined into one component, or some components may be added or removed.

The memory 310 may store instructions executable by processor 320. The memory 310 may store software or programs.

The processor 320 may execute instructions stored in the memory 310. The processor 320 may perform overall control of the charging station information providing server 300. The processor 320 may receive requests from external devices or various information through the communication interface unit 340 and store the received information in the storage 330. Additionally, the processor 320 may process received information. For example, the processor 320 may receive road condition information from the road information providing server 400, may receive information about the charging station from the charging station operator server 500, and may receive vehicle information from the vehicle information providing server 600. The processor 320 may perform processing to manage the received information and store the processed information in the storage 330. In addition, in response to a request received from the vehicle 100 or user terminal 200, the processor 320 may transmit charging station information or recommended charging route to the vehicle 100 or user terminal 200 through the communication interface unit 340 using information stored in storage 330.

The storage 330 may store various software and information necessary for the charging station information providing server 300 to provide charging station information. For example, the storage 330 may store programs running on the charging station information providing server 300, applications, and various data or information used for charging services. The storage 330 may store information received from the vehicle 100, the user terminal 200, the road information providing server 400, the charging station operator server 500, and the vehicle information providing server 600.

The storage 330 may store and manage condition information or user information for customized recommendations in a database for each user, or store and manage vehicle information in a database for each vehicle 100. The user information and vehicle information may be stored by matching user identification information or vehicle identification information. The storage 330 may store and manage information about charging stations, such as charging station-specific information or charging station status information, in a database for each charging station. The charging station-specific information refers to information that does not change even when the charging station is used, such as the charging station's identification information, location of charging station, type and speed of charging port. The charging station status information refers to information that may change depending on the use of the charging station, such as information on the usage status of the charger and whether the charger is lost.

In this way, the information stored in storage 330 may be converted into big data and used for services related to charging stations through various types of algorithms, analysis models, statistical models, evaluation models, recommendation models, etc.

For example, the processor 320 may find information about the user's preferred charging station characteristics and information on the payment method, such as a charging membership card or charging payment card that is mainly used, through the user's driving information records. For another example, the processor 320 may convert the battery status information of vehicle 100 into big data and may predict information, such as battery charge/discharge cycle information, battery charging time, battery output efficiency, expected battery life information, and battery replacement time. For another example, the processor 320 may calculate the usage congestion depending on a statistical model based on periodically collected usage status information of the charging station, or predict the expected waiting time of the charging station through an analysis model. In addition, the processor 320 may use a charging station evaluation model, based on charging station usage status information and charging station environment information to determine a list of available charging stations according to a charging station evaluation result indicating the reliability of the charging station.

The communication interface unit 340 may communicate with the vehicle 100, the user terminal 200, the road information providing server 400, the charging station operator server 500, the vehicle information providing server 600, etc. For example, the charging station information provision server 300, which provides a route recommendation service, may receive route configuration information, condition information for customized recommendations, vehicle information, etc. from the user terminal 200, may receive updated vehicle information, road condition information, and information about the charging station from external servers, and in response to a route recommendation request from an external device, may provide a recommended charging route.

The processor 320 may execute the instructions stored in the memory 310 to perform the following operations. According to one example, the processor 320 may receive a route recommendation request including route configuration information from an external device through the communication interface unit 340. The processor 320 may search for a direct route based on route configuration information in response to the received route recommendation request, select a charging station candidate group based on a direct route using a charging station selection model with an input of condition information for customized recommendations, vehicle information, road condition information, and information about charging stations, and configure at least one recommended charging route, based on the selected charging station candidate group using the route recommendation model. The processor 320 may transmit at least one recommended charging route to an external device through the communication interface unit 340.

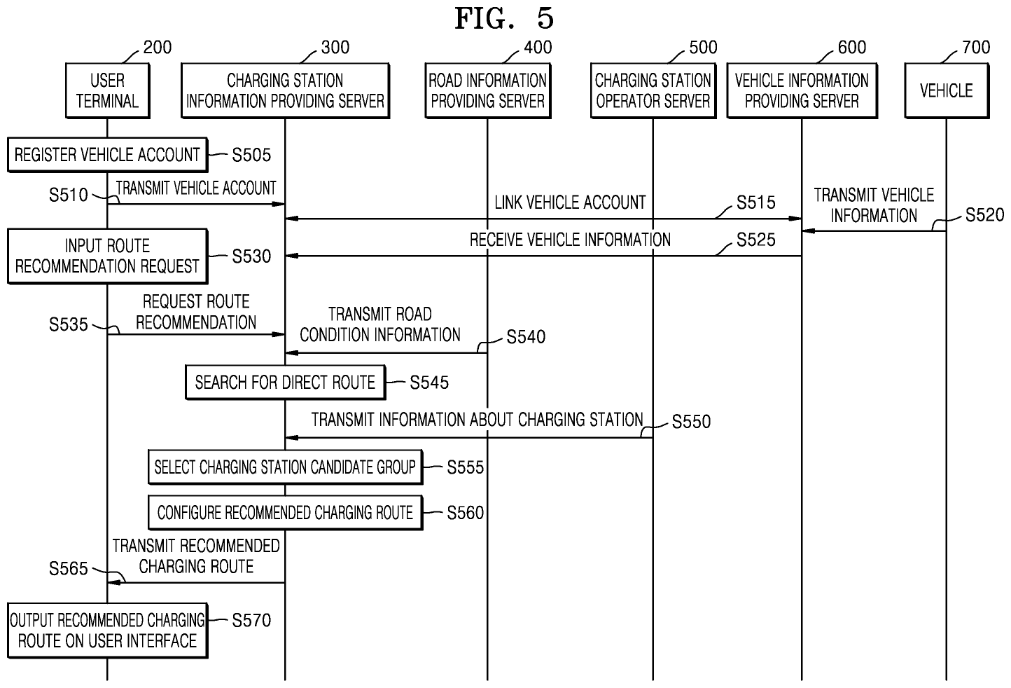

FIG. 5 is a diagram for explaining a process of providing a recommended charging route in response to a route recommendation request.

In operation S505, the user terminal 200 may run the charging station information providing application and register the vehicle account of the vehicle 100 in the user interface. The user may run the charging station information providing application and enter a vehicle account that may be linked to the vehicle information providing server 600.

In operation S510, the user terminal 200 may transmit the vehicle account to the charging station information providing server 300. The charging station information providing server 300 may receive the vehicle account registered by the user from the user terminal 200.

In operation S515, the charging station information providing server 300 may link the vehicle account to the vehicle information providing server 600. To do this, the charging station information providing server 300 may request the vehicle information providing server 600 to confirm whether the linking of vehicle accounts is valid, and the vehicle information providing server 600 may respond by confirming whether the vehicle account linkage is valid. When the vehicle account transmitted by the charging station information providing server 300 matches the vehicle account registered in the vehicle information providing server 600, the validity of the vehicle account may be recognized. The charging station information providing server 300 may encrypt and store the linked vehicle account.

In operation S520, the vehicle 100 may update the vehicle information stored in the vehicle information providing server 600 by transmitting vehicle information to the vehicle information provision server 600. The vehicle 100 may transmit vehicle information to the vehicle information providing server 600 when the user ends driving or at a set period.

In operation S525, the charging station information providing server 300 may receive vehicle information from the vehicle information providing server 600. The charging station information providing server 300 may receive a request for vehicle information from the user terminal 200 for route recommendation, or may receive vehicle information from the vehicle information providing server using a linked vehicle account at a predetermined period. Alternatively, whenever vehicle information is updated in the vehicle information providing server 600, the charging station information providing server 300 may receive the updated vehicle information. Vehicle information stored in the charging station information providing server 300 may be synchronized with vehicle information stored in the vehicle information providing server 600 through a linked vehicle account.

In operation S530, the user terminal 200 may receive a route recommendation request input from the user interface through execution of a charging station information provision application. In operation S515, the input of the route recommendation request may include not only route configuration information, but also condition information for customized recommendation, vehicle information, and scheduled departure time information. When the condition information for customized recommendation and vehicle information are transmitted to the charging station information providing server 300, they may be stored and managed in the database of the charging station information providing server 300. User information or vehicle information that occurs or changes each time the charging station information providing service is used may be updated in the database.

In operation S535, the user terminal 200 may transmit the route recommendation request to the charging station information providing server 300. The charging station information providing server 300 may receive a route recommendation request including route configuration information, when the user further inputs scheduled departure time information, the condition information for customized recommendation, and vehicle information in the user terminal 200, the charging station information providing server 300 may further receive the corresponding information from the user terminal 200.

In operation S540, the road information providing server 400 may transmit road condition information to the charging station information providing server 300. For example, the road information providing server 400 may transmit detailed road information or traffic situation information that changes with time to the charging station information providing server 300 upon request from the charging station providing server 300 or at a predetermined period. Accordingly, the charging station information providing server 300 may receive road condition information and utilize the road condition information for a route recommendation service.

In operation S545, the charging station information providing server 300 may search for a direct route based on the route configuration information. The charging station information providing server 300 may search for an optimal travel route that does not pass through a charging station as a direct route from the departure point to the destination included in the route configuration information based on the scheduled departure time. The charging station information providing server 300 may derive the optimal direct route using road condition information.

In operation S550, the charging station operator server 500 may transmit information about the charging station to the charging station information providing server 300. For example, the charging station operator server 500 may transmit charging station status information to the charging station information providing server 300 upon request from the charging station providing server 300 or at a predetermined period. Accordingly, the charging station information providing server 300 may receive information about the charging station and utilize the information about the charging station for a route recommendation service. The charging station information providing server 300 may obtain and manage charging station evaluation information indicating the reliability of the charging station based on the usage status information of the charging station and the environmental information of the charging station. Information on the usage status of the charging station may include the usage rate or frequency of use of the charging station during a predetermined period, recent usage information, usage congestion, etc. The charging station information providing server 300 may reflect the updated charging station status information and calculate usage congestion or predict the expected waiting time through a statistical model, analysis model, algorithm, etc. The environmental information of the charging station is information related to the building or location where the charging station is located and may include operating hours, availability for outsiders, parking fees, and difficulty of entering the parking lot. The reliability of a charging station indicates the probability that a user may use the charging station.

In operation S555, the charging station information providing server 300 may select a charging station candidate group, based on a direct route using a charging station selection model with an input of condition information for customized recommendation, vehicle information, road condition information, and information about the charging station. For example, the charging station information providing server 300 may select the first charging station candidate group, based on the charging station placement status near the direct route, the remaining battery capacity of vehicle 100, the charging station type preferred by the user, and road condition information at the scheduled departure time. The charging station information providing server 300 may search for a detour route with the shortest distance or a detour route with a minimum time passing through each charging station belonging to the first charging station candidate group, and obtain the distance difference or difference in time required between the detour route and the direct route. The charging station information provision server 300 may exclude the charging station from the first charging station candidate group when the detour distance to pass through the charging station is longer than a predetermined standard or the detour time takes longer. The charging station information providing server 300 may select the second charging station candidate group as the optimal charging station candidate group by removing the charging station of which detour distance or detour time does not satisfy predetermined conditions from the first charging station candidate group.

In operation S560, the charging station information providing server 300 may configure at least one recommended charging route, based on the selected charging station candidate group using the route recommendation model. The charging station information providing server 300 may configure a recommended charging route by calculating the minimum total charging amount (hereinafter, target charging amount) required to get from origin to destination, accumulating the charging amount at the charging stations passing through among the charging stations belonging to the selected charging station candidate group, and passing through at least one charging station until the accumulated charging amount is greater than the target charging amount. The charging amount at a passing charging station may be determined as an appropriate charging amount, based on charging efficiency and a charging limit indicating the upper limit of charging.

In operation S565, the charging station information providing server 300 may transmit at least one recommended charging route to the user terminal 200. The charging station information providing server 300 may transmit at least one recommended charging route, such as a recommended charging route with the shortest distance, a recommended charging route with the minimum time, and a recommended charging route with the minimum cost, to the user terminal 200.

In operation S570, the user terminal 200 may output at least one recommended charging route received from the charging station information providing server 300 to the user interface. The user terminal 200 may output at least one recommended charging route to the user interface based on the user's preferred priority. For example, the charging station information providing server 300 may receive a request for providing navigation to a destination, based on a recommended charging route from an external device such as a user terminal 200, and in response to the received navigation request, may provide the external device with a recommended charging route that reaches the destination in the minimum time or cost through the charging station.

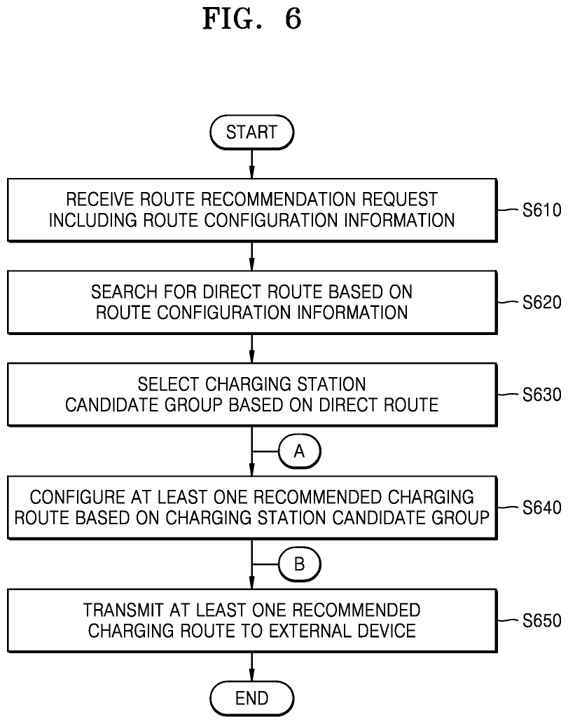

FIG. 6 is a flowchart showing a method of providing a recommended charging route performed by a charging station information providing server 300.

The charging station information providing server 300 may perform a method of providing a recommended charging route. Descriptions and terms already given will be omitted below. The charging station information providing server 300 may use information received from the vehicle 100, user terminal 200, road information providing server 400, charging station operator server 500, vehicle information providing server 600, etc. to provide a route recommendation service. The external device may be the vehicle 100 or the user terminal 200, but is not limited thereto.

In operation S610, the charging station information providing server 300 may receive a route recommendation request including route configuration information from an external device. To do this, the external device may run a charging station information provision application to provide a user interface and receive a route recommendation request input from the user.

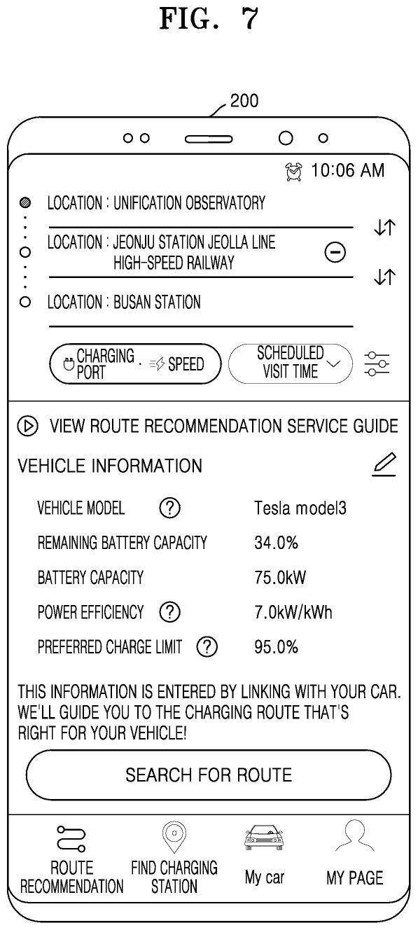

FIG. 7 is a diagram illustrating an example of a route recommendation request input through a user interface upon execution of a charging station information providing application.

Referring to FIG. 7, FIG. 7 shows the user interface when the user selects the route recommendation menu on the home screen of the charging station information providing application executed on the user terminal 200.

To use the route recommendation service, the user may input route configuration information such as arrival point, transit point, and destination into the user interface. The transit point may be added or removed according to the user's selection. The users may select conditional information for customized recommendations. For example, the users may specify conditions related to charging, such as the type of charging port, charging speed, and charging location type. Additionally, the user may set the scheduled departure time to the current time or an arbitrary time. The user may enter vehicle information. The user may input vehicle model, remaining battery capacity, battery capacity, power efficiency, and preferred charging limit directly through the user interface. When there is vehicle information linked through a vehicle account, vehicle information received from the charging station information providing server 300 may be automatically input into the user interface.

When all information to use the route recommendation service has been entered and the user presses the ‘Search Route’ button on the user interface, the user terminal 200 may transmit a route recommendation request to the charging station information providing server 300.

Referring again to FIG. 6, in operation S620, in response to the received route recommendation request, the charging station information providing server 300 may search for a direct route, based on the route configuration information included in the route recommendation request.

For example, based on the scheduled departure time, the charging station information providing server 300 may search for an optimal travel route that does not pass through a charging station from the departure point to the destination included in the route configuration information as a direct route. The charging station information providing server 300 may perform direct route search processing through the road information providing server 400, or may perform direct route search processing using road condition information received from the road information providing server 400.

In operation S630, the charging station information providing server 300 may select a charging station candidate group, based on the direct route using a charging station selection model with an input of condition information for customized recommendation, vehicle information, road condition information, and information about the charging station.

The charging station information providing server 300 may search for charging station candidates near the direct route using a charging station selection model. For example, the charging station information providing server 300 may select a first charging station candidate group, based on the charging station placement status near the direct route, the remaining battery capacity of the vehicle 100, the charging station type preferred by the user, and road condition information at the scheduled departure time.

The charging station information providing server 300 may search for an optimal route passing through each charging station belonging to the searched charging station candidate group. The charging station information providing server 300 may perform optimal route search processing through each charging station through the road information providing server 400, or may perform optimal route search processing using road condition information received from the road information provision server 400.

The charging station information providing server 300 may compare the difference in time or distance required between partial sections of the optimal route and the direct route corresponding to the optimal route. The charging station information providing server 300 may determine how much more time it takes or how much longer the detour distance is compared to the direct route, based on the optimal route to be detoured to pass through the charging station.

The charging station information providing server 300 may remove a charging station whose difference in required time or distance does not satisfy a predetermined standard from the charging station candidate group. For example, the charging station information providing server 300 may select the second charging station candidate group by removing some charging stations that do not satisfy the conditions from the first charging station candidate group as the optimal charging station candidate group, based on the difference in time or distance required between partial sections of the optimal route and the direct route corresponding to the optimal route, the status of charging stations by region, vehicle information, charging port type and speed of the charging station, etc.

In operation S640, the charging station information providing server 300 may configure at least one recommended charging route, based on the selected charging station candidate group using a route recommendation model.

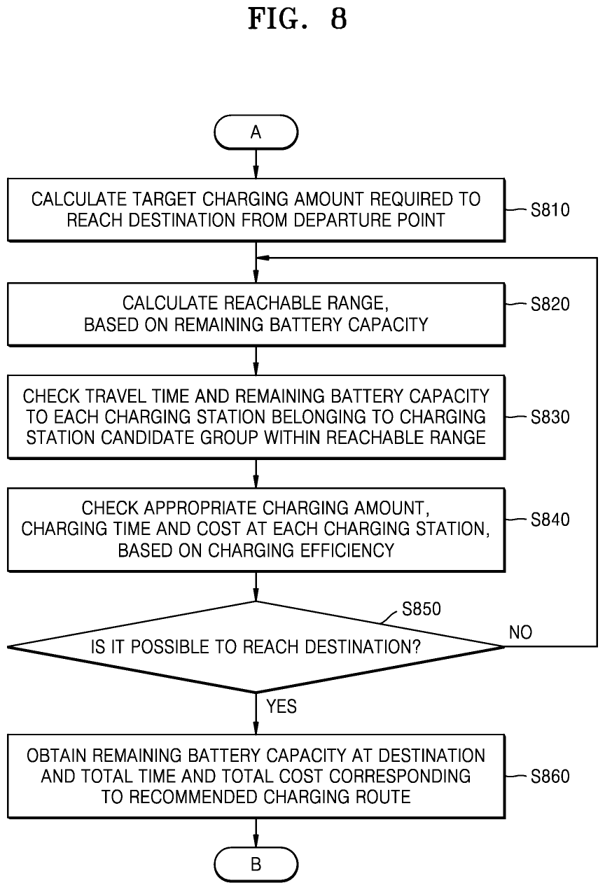

FIG. 8 is a detailed flowchart illustrating a process of configuring a recommended charging route, based on a charging station candidate group in a method of providing a recommended charging route.

In operation S810, the charging station information providing server 300 may calculate the target charging amount required to reach the destination from the departure point included in the route configuration information. The charging station information providing server 300 may adjust the target charging amount depending on vehicle information and whether or not an available charging station is located at the destination. For example, the target charge amount may be calculated by considering the current remaining battery capacity and performance per watt of the vehicle 100 and the travel distance, and depending on the density of available charging stations around the destination, the target charge amount may be set higher.

In operation S820, the charging station information providing server 300 may calculate the reachable range of the vehicle 100, based on the remaining battery capacity of the vehicle 100. The charging station information providing server 300 may calculate the reachable range, based on the remaining battery capacity of the vehicle 100 at the departure point or current point, in order to find a charging station that may be reached in the current situation among charging stations belonging to the charging station candidate group.

In operation S830, the charging station information providing server 300 may predict the travel time and remaining battery capacity to each charging station belonging to the charging station candidate group within a reachable range. The charging station information providing server 300 may predict the travel time to each charging station within a reachable range among all charging stations belonging to the charging station candidate group and the remaining battery capacity upon arrival at each charging station.

In operation S840, the charging station information providing server 300 may predict the appropriate charging amount at each charging station and the charging time and cost corresponding to the appropriate charging amount based on charging efficiency. The appropriate charge amount may be determined, based on the charger output of each charging station, charging efficiency characteristics depending on the battery capacity of the vehicle 100, and a charge limit indicating the upper limit of charge.

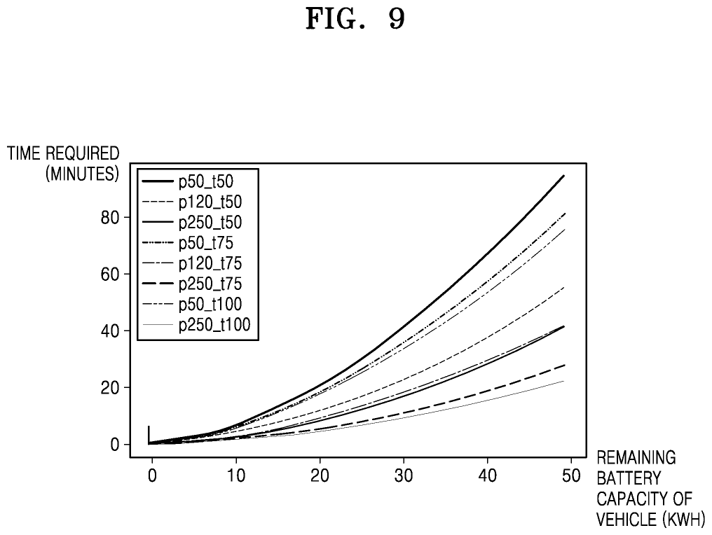

FIG. 9 is a graph for explaining charging efficiency, based on the relationship between charger output, battery capacity, and charging execution time.

The charging execution time of the battery of the vehicle 100 is not simply linearly proportional to the output of the charger, and may be affected by the battery capacity or remaining battery capacity of the vehicle 100, degree of deterioration, temperature, etc. Referring to FIG. 9, FIG. 9 shows a graph showing the change in charging execution time when charging the battery of the vehicle 100 for various combinations of the charger output of the charging station and the battery capacity of the vehicle 100. For example, in the graph of FIG. 9, the first curve from the top, p50_t50 represents the charging execution time when charging a battery with a 50 kWh battery capacity with a 50 kW charger output, and the second curve from the top, p50_t75 represents the charging execution time when charging a battery with a 75 kWh battery capacity with a 50 kW charger output.

Looking at the graph of FIG. 9, it may be seen that the slope of each curve increases more steeply as the battery of the vehicle 100 is charged. In other words, as the battery of the vehicle 100 is charged, the time required to charge the same capacity rapidly increases. That is, as the battery of the vehicle 100 is charged, the charging efficiency of the battery gradually decreases. Therefore, continuing to charge until the battery of the vehicle 100 is 100% fully charged may be disadvantageous for the user in terms of charging time or charging cost.

In consideration of this, depending on the charging efficiency, the charging station information providing server 300 may determine the appropriate charging amount at each charging station by ensuring that charging is performed at each charging station only up to a section in which charging efficiency is maintained a predetermined value or more within a preset charging limit. The charging station information providing server 300 may be provided with a charging efficiency database corresponding to various combinations of the charger output of the charging station and the battery capacity of the vehicle 100. The charging station information providing server 300 may predict the charging waiting time and charging time required to charge the appropriate amount of charge at each charging station, and predict parking fees, charging fees, and transportation fees (e.g. toll gate fees, etc.) for charging.

Referring again to FIG. 8, in operation S850, the charging station information providing server 300 may compare the cumulative charge amount after charging the appropriate charge amount with the target charge amount to complete or continue configuring a recommended charging route. When the vehicle 100 may reach the destination, the charging station information providing server 300 may complete a recommended charging route from the departure point to the destination. In this case, when the accumulated charge amount of the battery of the vehicle 100 exceeds the target charge amount, the vehicle 100 may be considered to have reached the destination. For example, when the cumulative charge amount exceeds the target charge amount, the charging station information providing server 300 may complete the recommended charging route and obtain the remaining battery capacity at the destination and the total time and total cost corresponding to the completed recommended charging route. When the cumulative charge amount is the target charge amount or less, the charging station information providing server 300 may perform the process again from S820 to repeat the process of configuring the recommended charging route until the destination is reached.

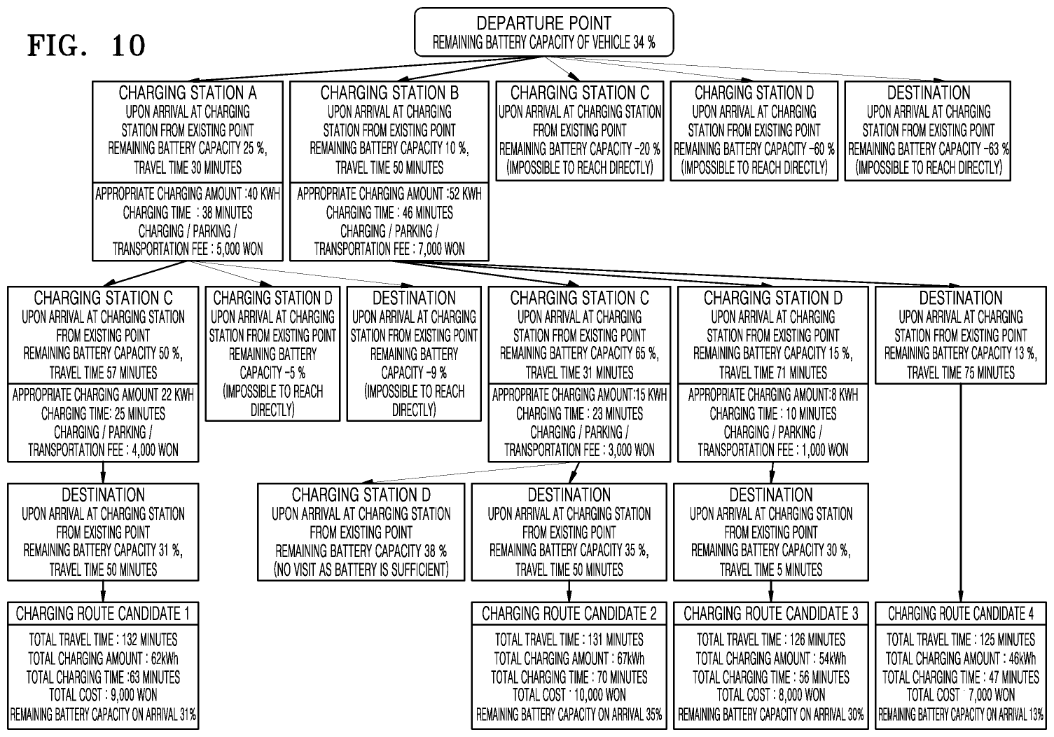

FIG. 10 is a diagram showing an example of configuring a recommended charging route, based on a charging station candidate group.

Referring to FIG. 10, it may be seen that when a vehicle 100 with a battery remaining of 34% from the departure point moves to the destination via a charging station, various recommended charging routes are generated. At the departure point, when a vehicle 100 with 34% battery remaining moves to charging station ‘A’ and charging station ‘B’ within reachable distance among the four charging stations ‘A’, ‘B’, ‘C’, and ‘D’ belonging to the charging station candidate group, the travel time to each charging station and the remaining battery capacity may be predicted. In order to move to the next point at each of charging station ‘A’ and charging station ‘B’, an appropriate charging amount may be determined in consideration of the remaining battery capacity, charging efficiency, charging limit, etc. of the vehicle 100, and the charging time and cost corresponding to the appropriate charging amount may be predicted. By repeating this operation until reaching the destination, which is the final location, each route taken by the vehicle 100 via charging stations to the destination may be a recommended charging route. For each recommended charging route, the cumulative charge amount, total time required, total cost, and remaining battery capacity upon arrival at the destination may be calculated. In the example of FIG. 10, a total of four recommended charging routes are configured, and the third recommended charging route is the recommended charging route with the shortest overall time. It may be seen that the recommended charging route with the lowest total cost is the fourth recommended charging route.

Referring again to FIG. 6, in operation S650, the charging station information providing server 300 may transmit the at least one recommended charging route to the external device. The charging station information providing server 300 may transmit at least one recommended charging route according to the priority of total required time or total cost to an external device that has requested a route recommendation service.

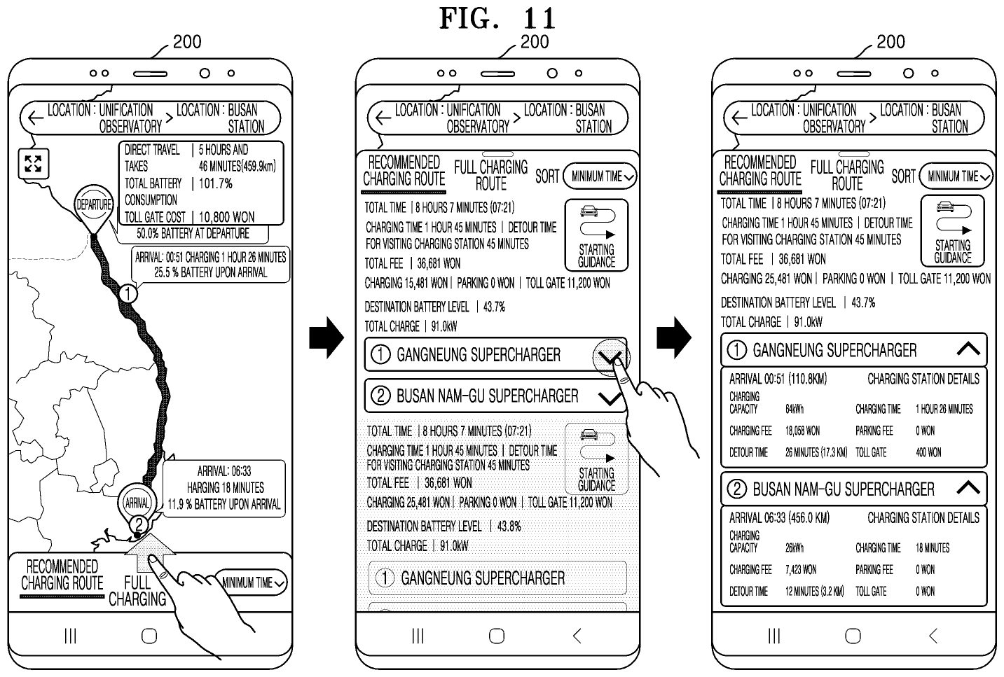

FIG. 11 is a diagram showing a recommended charging route output on the user interface by executing a charging station information providing application.

Referring to FIG. 11, the user terminal 200 may receive at least one recommended charging route from the charging station information providing server 300 and display the recommended charging route on the user interface. Referring to the example in FIG. 11, it may be seen that the recommended charging route that passes through a total of two charging stations from the departure point to the destination is displayed on the user interface as the first recommended charging route with the shortest overall time required. The user terminal 200 may display the total time and cost of traveling on a direct route that does not pass through a charging station on the user interface so that the user may compare the direct route with the recommended charging route. The user may pull up a menu at the lower portion of the user interface to see detailed information about at least one recommended charging route. When using each recommended charging route, the total time required, total cost required, remaining battery capacity and detailed information upon arrival at the destination, and the name of the charging station passing through may be provided. When the name of the charging station to be passed through is tapped, the distance and time to detour to pass through the charging station, charging amount, charging time, and cost may be provided.

The user may request provision of navigation corresponding to the recommended route by pressing the ‘Start Guidance’ button for the desired recommended charging route among the ‘Start Guidance’ buttons assigned to each recommended charging route in the user interface. As a result, the user may call the navigation application and use the navigation service according to the recommended charging route.

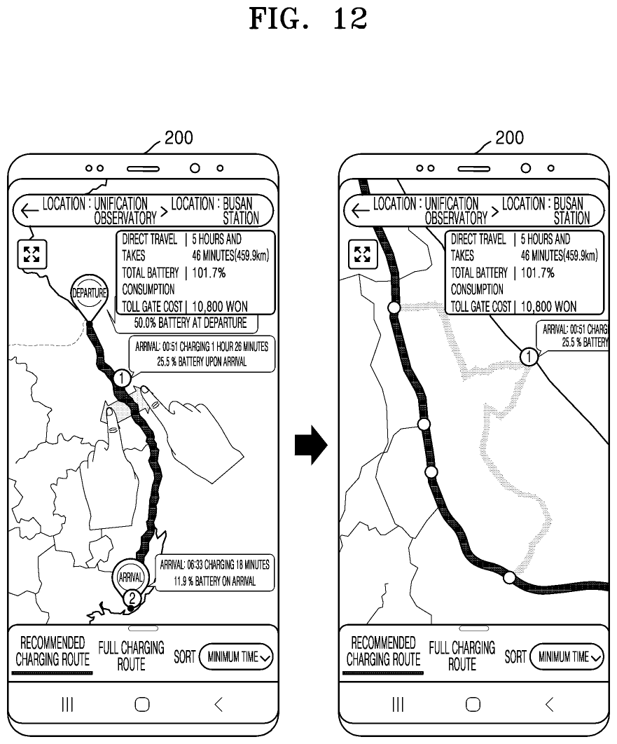

FIG. 12 is a diagram showing a detour route for via a charging station on a recommended charging route in the user interface by executing a charging station information providing application.

Referring to FIG. 12, users may intuitively check the detour route on the recommended charging route displayed on the user interface by comparing the detour route with the direct route to see how much detour they have to take to pass through the charging station. Referring to the example in FIG. 12, to check the location and travel route of the first charging station passing through on the recommended charging route, the user may perform a pinch-out operation near the charging station on the user interface of the user terminal 200 to enlarge the view near the charging station. Referring to the example in FIG. 12, because there are no charging stations on a highway, FIG. 12 shows a detour route that takes a detour to the location of the first charging station, performs charging, and then rejoins the highway.

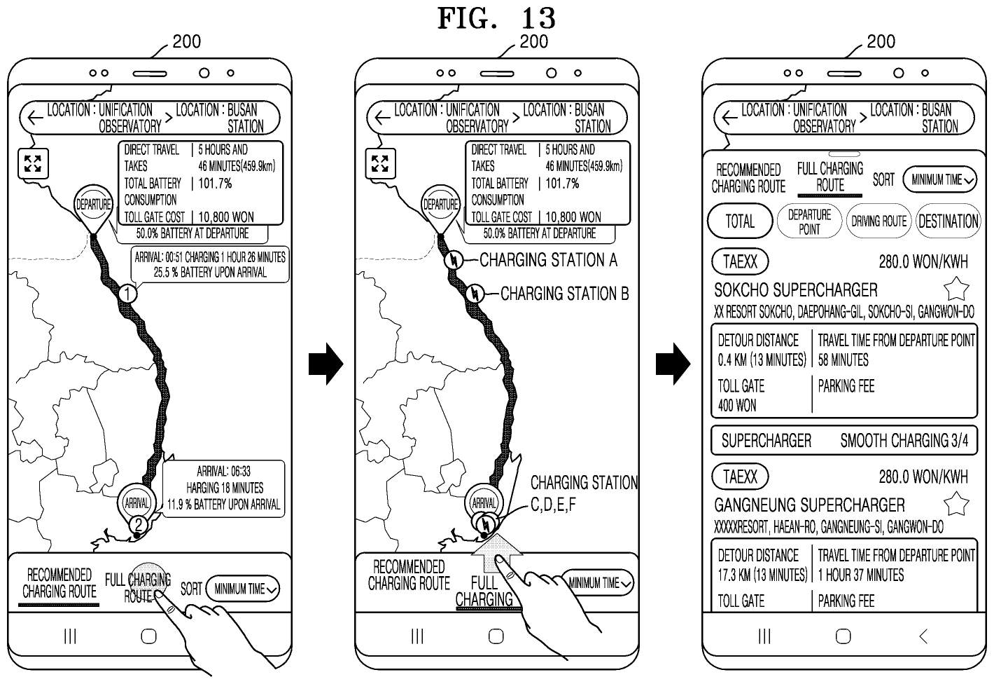

FIG. 13 is a diagram showing all charging stations included in the charging station candidate group selected to form a recommended charging route.

Referring to FIG. 13, the user may check all charging stations included in the charging station candidate group in addition to the charging stations on the recommended charging route displayed on the user interface. Referring to the example in FIG. 13, users may check the ‘full charging station route’ item in the menu at the lower portion of the user interface. When the ‘full charging station route’ item is tapped, the locations of all charging stations included in the charging station candidate group may be displayed on the charging route of the user interface. Referring to the example in FIG. 13, it may be seen that charging stations ‘A’, ‘B’, ‘C’, ‘D’, ‘E’, and ‘F’ are displayed at the corresponding positions of each charging station in the user interface. Through this, the user may roughly check the location of a charging station near the recommended charging route while traveling to the destination, even though it was not used on the recommended charging route. The two charging stations passed through in the recommended charging route in FIG. 13 may be charging station ‘B’ and charging station ‘F’, and the approximate locations of other charging stations may be confirmed.

Users may pull up the menu at the lower portion of the user interface to check detailed information about all charging stations belonging to the charging station candidate group. In this case, all charging stations may be identified separately for each charging station corresponding to the departure point, driving route, and destination. For each charging station, information about the charging station may be provided, such as name and address, detour distance to pass through the charging station, travel time from the departure point, cost required, charging port type, and charging station usage status.

In order to execute certain operations for performing a method of providing a recommended charging route in a terminal device of an external device such as the vehicle 100 or the user terminal 200, each of the above-described embodiments may be provided in the form of a computer program or application stored on a medium. In addition, in order to execute certain operations in which the method of providing a recommended charging route is performed by the charging station information providing server 300, each of the above-described embodiments may be provided in the form of a computer program or application stored on a medium.

In other words, each of the above-described embodiments may be provided in the form of a computer program or application stored in a medium that causes at least one processor of a terminal device of an external device such as the vehicle 100 or the user terminal 200 to perform certain operations to perform a method of providing a recommended charging route. In addition, each of the above-described embodiments may be provided in the form of a computer program or application stored in a medium that causes at least one processor of a server to perform certain operations to perform a method of providing a recommended charging route.

The above-described embodiments may be implemented in the form of a computer-readable storage medium that stores instructions and data executable by a computer or processor. At least one of the instructions and data may be stored in the form of a program code, and when executed by a processor, may generate a predetermined program module and perform a predetermined operation. Such computer-readable storage media may include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks (SSD), may store instructions or software, related data, data files, and data structures, and may be any device that may provide instructions or software, related data, data files, and data structures to a processor or computer so that the processor or computer may execute the instructions.

So far, the description has focused on embodiments. A person skilled in the art to which the disclosed embodiments belong understands that the disclosed embodiments may be implemented in a modified form without departing from the essential characteristics. Therefore, the disclosed embodiments should be considered from an illustrative rather than a restrictive perspective. The scope of the invention is shown in the claims rather than the description of the above-described embodiments, and all differences within the equivalent scope should be construed as being included in the scope of the invention.

1. A charging station information providing server comprising:
a communication interface unit;
a memory to store instructions; and
a processor configured to execute instructions to receive a route recommendation request including route configuration information from an external device through the communication interface unit, in response to the received route recommendation request, search for a direct route, based on the route configuration information, select a charging station candidate group based on the direct route using a charging station selection model with an input of condition information for customized recommendation, vehicle information, road condition information, and information about charging stations, configure at least one recommended charging route, based on the selected charging station candidates using a route recommendation model, and transmit the at least one recommended charging route to the external device through the communication interface unit.

2. The charging station information providing server of claim 1, wherein the processor executes the instructions to search for an optimal travel route that does not pass through a charging station from a departure point to a destination included in the route configuration information as the direct route, based on a scheduled departure time.

3. The charging station information providing server of claim 1, wherein the processor executes the instructions to search for a charging station candidate group near the direct route using the charging station selection model, search for an optimal route passing through each charging station in the searched charging station candidate group, compare a difference in time or distance required between partial sections of the optimal route and the direct route corresponding to the optimal route, and select the charging station candidate group by removing the charging station of which the difference does not satisfy a predetermined standard from the charging station candidate group.

4. The charging station information providing server of claim 1, wherein the processor executes the instructions to calculate target charging amount required to reach a destination from a departure point included in the route configuration information, calculate a reachable range of a vehicle, based on a remaining battery capacity of the vehicle, predict a travel time and the remaining battery capacity to each charging station belonging to the charging station candidate group within the reachable range, predict appropriate charging amount at each charging station and the charging time and cost corresponding to the appropriate charging amount, based on charging efficiency, and configure the at least one recommended charging route by comparing a cumulative charge amount after charging the appropriate charge amount with the target charge amount, and by completing or continuing to configure a recommended charging route.

5. The charging station information providing server of claim 4, wherein the processor executes the instructions to,
when the cumulative charge amount exceeds the target charge amount, obtain the remaining battery capacity at the destination and a total time and total cost corresponding to the completed recommended charging route, and when the cumulative charge amount is less than or equal to the target charge amount, continue to configure the recommended charging route until the destination is reached.

6. The charging station information providing server of claim 4, wherein the processor executes the instructions to adjust the target charging amount, depending on the vehicle information and a deployment of available charging stations at the destination.

7. The charging station information providing server of claim 4, wherein the processor executes the instructions to determine the appropriate charging amount, based on the charger output of each charging station, charging efficiency characteristics depending on a battery capacity of the vehicle, and a charging limit indicating an upper charging limit.

8. A method of providing a recommended charging route performed by a charging station information providing server, the method comprising:
receiving a route recommendation request including route configuration information from an external device;
in response to the received route recommendation request, searching for a direct route based on the route configuration information;
selecting a charging station candidate group based on the direct route using a charging station selection model with an input of condition information for customized recommendation, vehicle information, road condition information, and information about charging stations;
configuring at least one recommended charging route, based on the selected charging station candidate group using a route recommendation model; and
transmitting the at least one recommended charging route to the external device.

9. The method of claim 8, wherein
the searching for the direct route includes searching for an optimal travel route that does not pass through a charging station from a departure point to a destination included in the route configuration information, based on a scheduled departure time.

10. The method of claim 8, wherein
the selecting of the charging station candidates includes
searching for a charging station candidate group near the direct route using the charging station selection model;
searching for an optimal route passing through each charging station belonging to the searched charging station candidate group;
comparing a difference in time or distance required between partial sections of the optimal route and the direct route corresponding to the optimal route; and
removing a charging station of which the difference does not satisfy a predetermined standard from the charging station candidate group.

11. The method of claim 8, wherein
the configuring of the at least one recommended charging route includes calculating a target charging amount required to reach a destination from a departure point included in the route configuration information;
calculating a reachable range of a vehicle, based on a remaining battery capacity of the vehicle;
predicting travel time and the remaining battery capacity to each charging station belonging to the charging station candidate group within the reachable range;
based on charging efficiency, predicting an appropriate charging amount at each charging station, and a charging time and cost corresponding to the appropriate charging amount; and
completing or continuing to configure the recommended charging route by comparing the cumulative charge amount after charging the appropriate charge amount with the target charge amount.

12. The method of claim 11, wherein
the completing or continuing to configure the recommended charging route includes,
when the cumulative charge amount exceeds the target charge amount, obtaining the remaining battery capacity at the destination and a total time and total cost corresponding to the completed recommended charging route, and when the cumulative charge amount is less than or equal to the target charge amount, repeating configuring the recommended charging route until the destination is reached.

13. The method of claim 11, wherein
the calculating of the target charging amount further includes adjusting the target charging amount depending on the vehicle information and whether an available charging station is located at the destination.

14. The method of claim 11, wherein
the appropriate charging amount is determined, based on a charger output of each charging station and the charging efficiency characteristics depending on the battery capacity of the vehicle and a charging limit indicating an upper charging limit.

15. A charging station information providing application stored in a medium and configured to cause at least one processor of a terminal device to perform a method of providing a recommended charging route,
wherein the method of providing the recommended charging route comprises detecting an input of a route recommendation request including route configuration information in a user interface upon execution of a charging station information providing application,
transmitting the route recommendation request to a charging station information providing server,
in response to the transmitting of the route recommendation request, receiving, from the charging station information providing server, at least one recommended charging route, wherein the at least one recommended charging route is configured by the charging station information providing server searching for a direct route based on the route configuration information, selecting a charging station candidate group based on the direct route using a charging station selection model with an input of condition information for customized recommendation, vehicle information, road condition information, and information about charging stations, and configuring the at least one recommended charging route, based on the selected charging station candidate group using a route recommendation model, and
changing and outputting the user interface, based on the received at least one recommended charging route.
